(19) United States
(12) Patent Application Publication
(10) Pub. No.: US 2026/0178285 A1
(43) Pub. Date: Jun. 25, 2026

(54) APPLICATION DESIGN GENERATION SYSTEM

(71) Applicant: Oracle International Corporation, Redwood Shores, CA (US)

(72) Inventors: Sanoop Kizhakkeveettil, Malappuram (IN); Sidharth Sasi Kumar, Kozhikode (IN); Arun Bhaskaran, Alappuzha (IN); Sayooj Othikandy, Kannur (IN)

(73) Assignee: Oracle International Corporation, Redwood Shores, CA (US)

(21) Appl. No.: 18/988,524

(22) Filed: Dec. 19, 2024

(51) Int. Cl. G06F 8/35; G06F 8/20

(52) U.S. Cl. CPC G06F 8/35; G06F 8/20

(57) ABSTRACT

The present disclosure describes techniques that facilitate the efficient generation of an application design and an application based on a set of application requirements related to the application. In certain examples, an application generation system is disclosed. The system obtains a set of application requirements for generating an application design for an application. The system generates multiple application designs using a combination of machine language (ML) techniques and Retrieval Augmented Generation (RAG) techniques. The system then evaluates the multiple application designs and selects a particular application design from among the multiple application designs that is deemed to be “best” aligned with the set of application requirements related to the application. As part of generating the multiple application designs and selecting an application design from the multiple application designs, in certain examples, the system provides the selected application design via a user interface of a computing device.

### BACKGROUND

Application developers face several challenges while developing applications in today's world. Some of these challenges include accurately describing users requirements and clearly documenting and translating these requirements into robust, full-fledged, and tangible applications that meet the needs of users. There are other challenges that can arise when developing applications such as ensuring that the application can swiftly adapt to changes, has intuitive and user-friendly interfaces, and is easy to interact with to accomplish various tasks. Traditional documentation processes used for application development typically involve manually translating diverse requirements into technical design specifications (i.e., into an application design) for an application. This is typically a time consuming task that is prone to errors. Thus, there is a need for developing techniques that facilitate more efficient application design and development than what is possible by existing implementations.

### BRIEF SUMMARY

The present disclosure relates generally to techniques that facilitate the efficient generation of an application design for an application based on a set of application requirements related to the application. More specifically, but not by way of limitation, this disclosure describes techniques for evaluating multiple application designs generated for an application and selecting a particular application design from among the multiple application designs that is deemed to be “best” aligned with the set of application requirements related to the application.

In some embodiments, a method includes obtaining a set of application requirements for generating an application design for an application. The set of application requirements comprise a set of features related to the application, a description of the attributes of the application, a description of one or more pages in the application, and a set of workflows for generating the application design for the application. The method further includes generating a first set of multiple application designs for the set of application requirements using a first machine language (ML) model and a set of prompts. The set of prompts are generated based on the user input. The method includes generating, based on a set of relevant application designs related to the set of application requirements, a second set of multiple application designs for the set of application requirements using a second machine language (ML) model. The set of relevant application designs are identified by searching a corpus of stored application design.

In some embodiments, the method further includes selecting a subset of application designs from among the first set of multiple application designs and the second set of multiple application designs based on a set of quality values related to application designs in the first set of application designs and the second set of application designs. The method further includes providing the subset of selected application designs as one or more application designs for the application to be generated.

In some embodiments, the method includes obtaining feedback regarding the one or more application designs comprised in the subset of selected application designs, evaluating the feedback to select a final application design for the application from among the subset of selected application designs and providing the final application design as an application design for the application to be generated.

In some embodiments, the feedback indicates that each application design in the subset of selected application designs is approved and the method includes evaluating the feedback to select a final application design for the application from among the subset of selected application designs. The evaluation of the feedback comprises computing a set of updated quality values for the one or more application designs in the subset of selected application designs, adding the application designs in the subset of selected application designs and the updated quality values associated with the application designs to a positive samples deque memory in a memory buffer in the application generation system, identifying the application design from among the subset of selected application designs with the highest quality value and providing the identified application design as the final application design for the application to be generated.

In some embodiments, the feedback indicates that at least one application design in the subset of application designs is rejected and the method includes evaluating the feedback to select a final application design for the application from among the subset of selected application designs. evaluation of the feedback comprises computing an updated quality value for the rejected application design, adding the rejected application design and the updated quality value associated with the rejected application design to a negative samples deque memory in a memory buffer of the application generation system, computing a set of updated quality values for the approved application designs in the subset of selected application designs, adding the approved application designs and the updated quality values associated with the approved application designs to a positive samples deque memory in a memory buffer in the application generation system, identifying the application design from among the subset of selected application designs with the highest quality value and providing the identified application design as the final application design for the application to be generated

In some embodiments, the feedback indicates that an application design in the subset of selected application designs is approved and the method includes evaluating the feedback to select a final application design for the application from among the subset of selected application designs. The evaluation of the feedback comprises obtaining information identifying a modification to the application design, generating an application design feature vector for the modified application design and computing an updated quality value for the modified application design and adding the modified application design and the quality value associated with the modified application design to a positive samples deque memory in a memory buffer of the application generation system.

In some embodiments, the method includes providing the modified application design as the final application design for the application to be generated.

In some embodiments, the method includes obtaining a set of application design feature vectors that relate to the first set of multiple application designs and the second set of multiple application designs, for each application design feature vector in the set of application design feature vectors, obtaining a quality value for the application design feature vector and selecting the subset of application designs from among the first set of multiple application designs and the second set of multiple application designs based on the quality values obtained for the set of application design feature vectors.

In some embodiments, the method includes selecting one or more application design feature vectors from the set of application design feature vectors using a selection policy and identifying application designs from among the first set of multiple application designs and the second set of multiple application designs that relate to the selected application design feature vectors. In some examples, the selection policy randomly selects application design feature vectors and the quality values associated with the application design feature vectors from the set of application design feature vector. In other examples, the selection policy selects one or more application design feature vectors from the set of application design feature vectors having the highest quality values. In some examples, a quality value represents a value that is obtained as a result of selecting a particular application design from among the first set of application designs and the second set of application designs

In some embodiments, the method includes obtaining a set of quality metrics related to an application design in the first subset of application designs and the second subset of application designs, for each quality metric in the set of quality metrics, obtaining a weight for the quality metric, for each quality metric in the set of quality metrics, computing a value for the quality metric and computing an application design schema quality score for the application design based on the values computed for the set of quality metrics and the set of weights obtained for the set of quality metrics.

In some embodiments, the method includes transmitting the application design schema quality score for the application design to a prompt generator in the application generation system, generating a set of modified prompts based on the application design schema quality score; and generating, using the first ML model and the set of modified prompts, an updated application design for the application design.

In some embodiments, the method includes obtaining an input that identifies a pre-generated application design for an application and information identifying a set of modifications related to the application design, generating an updated application design for an application based on a set of prompts and the set of modifications, where the set of prompts are generated based on the input and providing the updated application design as an application design for the application to be generated.

Some embodiments include a system that includes one or more processing systems and one or more computer-readable media storing instructions which, when executed by the one or more processing systems, cause the system to perform part or all of the operations and/or methods disclosed herein.

Some embodiments include one or more non-transitory computer-readable media storing instructions which, when executed by one or more processing systems, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many

### BRIEF DESCRIPTION OF THE DRAWINGS

Features, embodiments, and advantages of the present disclosure are better understood when the following Detailed Description is read with reference to the accompanying drawings.

FIG. 1 depicts an example computing environment comprising an application generation system (AGS) that includes capabilities for generating an application design for an application based on a set of application requirements related to the application, according to certain embodiments.

FIG. 2 depicts a simplified flowchart depicting the processing performed by the AGS shown in FIG. 1, according to certain embodiments.

FIG. 3 is an example illustration of an application requirement document that identifies a set of application requirements for generating an application design for an application, in accordance with certain embodiments.

FIG. 4 depicts a simplified flowchart depicting the processing performed by the RL subsystem in the AGS shown in FIG. 1 to identify and select a subset of application designs for an application from among multiple application designs, according to certain embodiments.

FIG. 5 depicts a simplified flowchart depicting the processing performed by the RL subsystem in the AGS shown in FIG. 1 to select a single application design from among a selected subset of application designs based on user feedback, according to certain embodiments.

FIG. 6 depicts a simplified flowchart depicting the processing performed by the RL subsystem in the AGS shown in FIG. 1 to select a single application design from among the selected application designs based on user feedback, according to certain embodiments.

FIG. 7 depicts a simplified flowchart depicting the processing performed by the RL subsystem in the AGS shown in FIG. 1 to select a single application design from among the selected application designs based on user feedback, according to certain embodiments.

FIG. 8 depicts an example of a computing environment comprising an application generation system (AGS) that includes an application design quality metrics evaluation system for evaluating the quality of an application design for an application, according to certain embodiments.

FIG. 9 depicts a simplified flowchart depicting the processing performed by the application design quality metrics evaluation subsystem in the AGS, according to certain embodiments.

FIG. 10 depicts a simplified flowchart depicting the processing performed by the AGS to generate an updated application design for an application, according to certain embodiments.

FIG. 11 is a block diagram illustrating one pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating an example computer system, according to at least one embodiment

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to techniques that facilitate the efficient generation of an application design for an application based on a set of application requirements related to the application. More specifically, but not by way of limitation, this disclosure describes techniques for evaluating multiple application designs generated for an application and selecting a particular application design from among the multiple application designs that is deemed to be “best” aligned with the set of application requirements related to the application.

As previously noted, translating a set of diverse user requirements into a full-fledged tangible application can be a challenging and manual task that is prone to errors. The present disclosure describes an application generation system (AGS) that is capable of accelerating the application development lifecycle by developing a solution that can automatically translate diverse user requirements into an application design for an application. Using the disclosed system, a user can input a set of application requirements for generating an application design for an application and then generate a fully functional application based on the application design. The application design generated by the system comprises robust and responsive user interfaces that align with the set of application requirements. Using the disclosed system, users need not be concerned about complex architecture and programming languages required to build complex application designs during the application development process. In certain embodiments, the system additionally includes capabilities to generate and deploy a fully functional application based on the selected application design for its users.

In certain examples, the set of application requirements describe a set of functionalities, capabilities, and features related to generating an application design for an application. For instance, a set of application requirements may describe information related to how a user should use the application, describe a set of features (e.g., description of the attributes) to be implemented by the application, a list of pages required to build the application, the logic (workflows, algorithms) needed to build the application and so on. In certain instances, the set of application requirements may additionally describe information related to the design complexity of the application, describe the security and privacy requirement related to the application, and so on.

The AGS then converts the set of application requirements into a full-fledged application design for the application using a combination of machine language (ML) techniques and retrieval augmented generation (RAG) techniques. The “application design” generated by the AGS comprises a set of technical specifications that describe both the functional aspects as well as the non-functional aspects of the application. For instance, an application design for an application may comprise a set of user interface (UI) elements associated with the application, the user experience (UX) of how users interact with and use the application, the database schema of the application, a description of the objects attributes used by the application, the code implemented by the application, and so on.

In certain embodiments, the AGS includes capabilities to generate multiple application designs for an application using ML techniques and RAG techniques. The AGS then evaluates the multiple application designs and selects a single application design that is deemed to be the “best” among the multiple application designs using a Reinforcement Learning (RL) technique. The evaluation of the multiple application designs performed using the Reinforcement Learning (RL) technique continuously improves the accuracy, stability and relevance of design predictions that are output by the AGS, in real-time. As part of generating the multiple application designs and selecting an application design from the multiple application designs, in certain examples, the system may also display the selected application design via a UI of a computing device of the user as described in this disclosure.

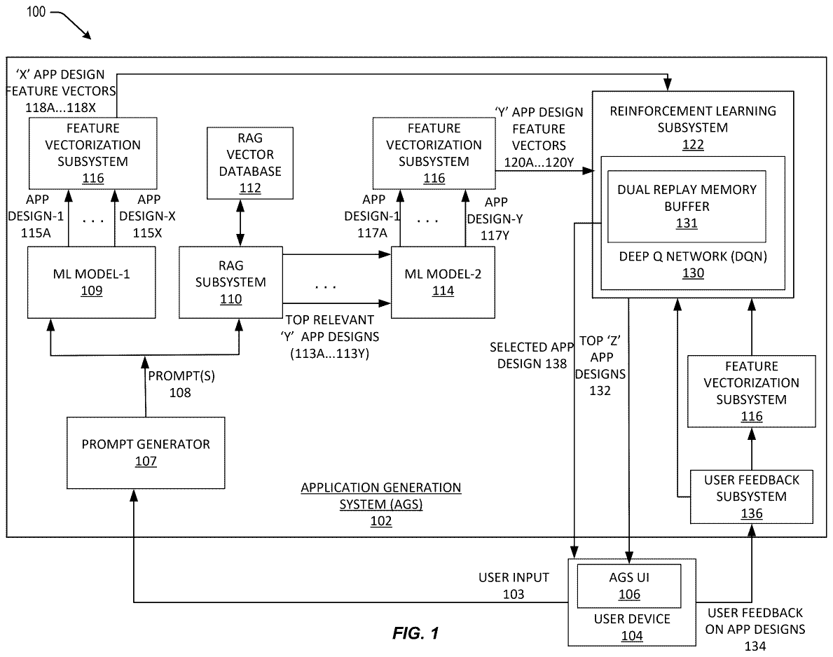

Referring now to the drawings, FIG. 1 depicts an example computing environment 100 comprising an application generation system (AGS) 102 that includes capabilities for generating an application design for an application based on a set of application requirements related to the application, according to certain embodiments. The AGS 102 may be implemented using one or more computing systems. For example, the computing systems may execute computer-readable instructions (e.g., code, program) to implement the AGS system 102. As depicted in FIG. 1, the AGS 102 includes various computing systems such as a prompt generator 107, one or more machine learning models (e.g., ML model-1 109, ML model-2 114), a Retrieval Augmented

Generation (RAG) subsystem 110, a feature vectorization subsystem 116, a reinforcement learning (RL) subsystem 122 and a user feedback subsystem 136. The systems and subsystems depicted in FIG. 1 may be implemented using only software (e.g., code, instructions, program) executed by one or more processing units (e.g., processors, cores) of a computing system, hardware, or combinations thereof. The software may be stored on a non-transitory storage medium (e.g., on a memory device).

The AGS 102 may be implemented using various different configurations. In certain embodiments, the AGS 102 may represent a computing system of an entity (for e.g., an organization, an enterprise, or an individual) that provides application design generation functionality to its users. In other embodiments, the AGS 102 may be implemented on one or more servers of a cloud provider network and its application design generation services may be provided to subscribers of cloud services on a subscription basis. The functionality to provide application design functionality, as described in this disclosure, may be offered as part of the service. A customer can subscribe to the service to generate multiple application designs based on an application requirement from a user, evaluate the multiple application designs and select a single application design based on the evaluation for its users. As part of generating the multiple application designs and selecting an application design from the multiple application designs, in certain examples, the service may also display the selected application design via a UI of a computing device of the requesting subscriber as described in this disclosure.

Computing environment 100 depicted in FIG. 1 is merely an example and is not intended to unduly limit the scope of claimed embodiments. One of ordinary skill in the art would recognize many possible variations, alternatives, and modifications. For example, in some implementations, the system can be implemented using more or fewer subsystems than those shown in FIG. 1, may combine two or more subsystems, or may have a different configuration or arrangement of subsystems.

In certain approaches, the AGS 102 includes capabilities for generating an application design for an application based on a set of application requirements related to the application. The AGS 102 may be configured to generate application designs for various types of applications. For instance, the AGS 102 may be configured to generate an application design for a consumer goods application that manages information related to orders and inventory of customers, generate an application design for a warranty application that manages warranty information related to vehicles and so on. An “application design” for an application (also referred to herein as an “application blueprint”) comprises a set of technical specifications that describe both the functional aspects as well as the non-functional aspects of the application. For instance, an application design for an application comprises a set of user interface (UI) elements associated with the application, the user experience (UX) of how users interact with and use the application, the database schema of the application, a description of the objects attributes used by the application, the code implemented by the application, and so on.

In certain implementations, the AGS 102 may be configured to receive a set of application requirements for generating an application design for an application. For instance, a user of the AGS 102 can request the AGS 102 to generate an application design for an application by providing a user input 103 that identifies a set of application requirements related to the application. The user input 103 can be provided by the user in text form (e.g., by typing in sentence(s) or a text fragment that identifies a set of application requirements related to the application). In certain approaches, the set of application requirements can be described in an application requirements document. For example, a user may specify a user input that identifies a location (e.g., a universal resource locator (URL)) of the application requirement and provide the document to the AGS 102 for processing.

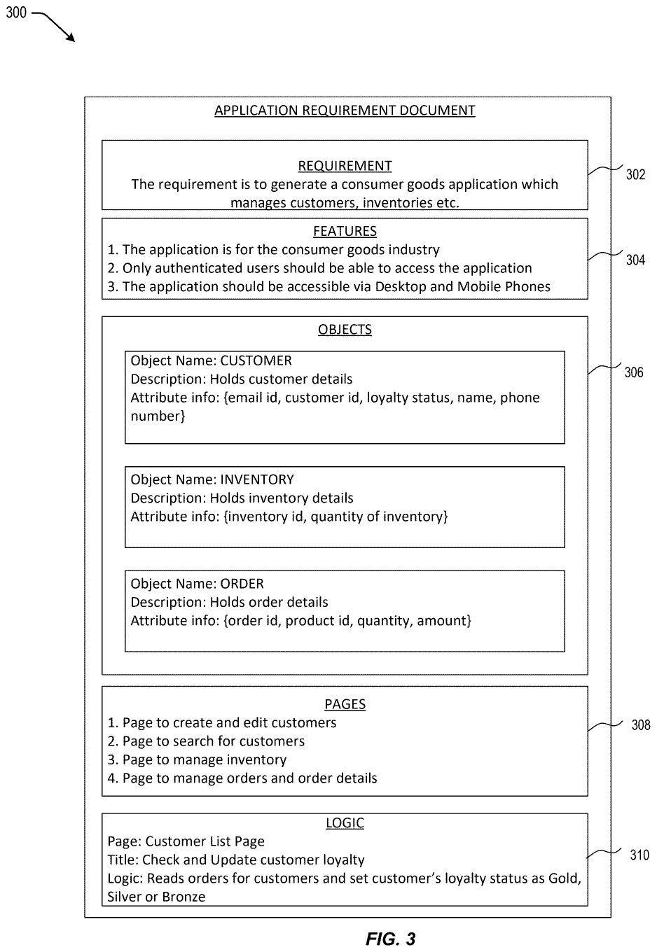

The set of application requirements describe a set of functionalities, capabilities, and features related to generating an application design for an application. For instance, a set of application requirements may describe information related to how a user should use an application, describe a set of features (e.g., description of the attributes) to be implemented by the application, a list of pages required to build the application, the logic (workflows, algorithms) needed to build the application and so on. In certain instances, the set of application requirements may additionally describe information related to the design complexity of the application, describe the security and privacy requirement related to the application, and so on. An example of an application requirements document that identifies a set of application requirements related to an application is shown in FIG. 3.

The AGS 102 may be configured to receive the user input 103 in various ways. For instance, in one approach, as depicted in FIG. 1, a user of the AGS 102 may provide the user input 103 using a user device 104 that is communicatively coupled to the AGS 102, possibly via one or more communication networks. The user device 104 may be of various types, including but not limited to, a mobile phone, a tablet, a desktop computer, and the like. In certain examples, the user may utilize a user interface (UI) (which may be a graphical user interface (GUI)) 106 of the AGS system 102 to provide a user input 103 that identifies a set of application requirements for an application. In other examples, the set of application requirements need not be provided by a user and may be provided directly to the AGS 102 via a cloud service or a third party system.

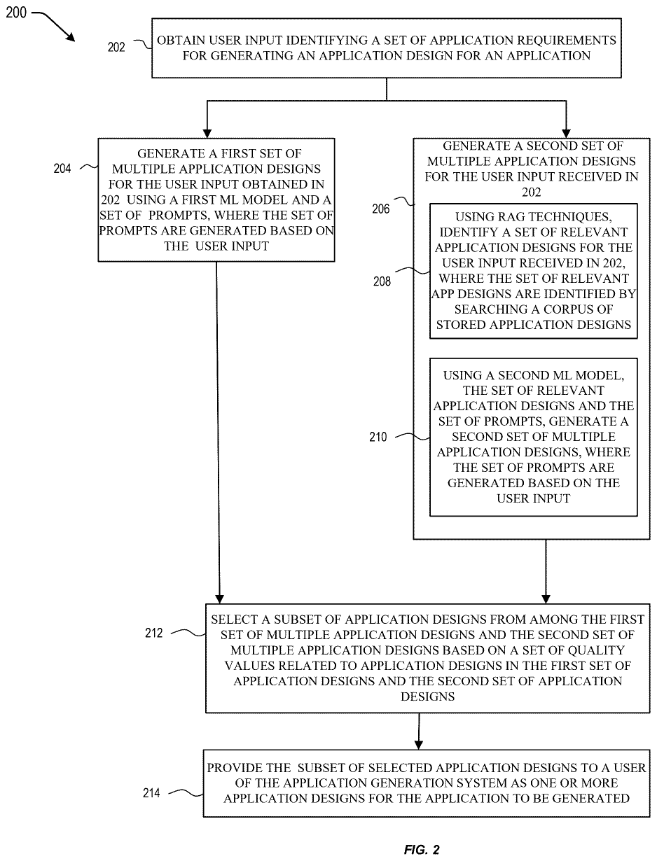

The AGS 102 may then be configured to perform a series of processing steps based on the user input. These processing steps may include, for example, converting the user input into a set of prompts that are analyzed by a set of Artificial Intelligence (AI) agent(s) using a combination of machine language (ML) techniques and retrieval augmented generation (RAG) techniques and receiving a set of responses (e.g., one or more application designs generated for the application) from the AI agent(s) based on the set of prompts. The processing further includes identifying and selecting one or more application designs for the application based on the responses received from the AI agent(s). In certain embodiments, the AGS 102 includes capabilities to generate multiple application designs for an application using a combination of ML models and RAG techniques. The AGS 102 may utilize various types of ML models, such as language models (e.g. BERT) and large language models (LLMs) such as GPT-4 to generate multiple application designs simultaneously for an application. For instance, as shown in the embodiment depicted in FIG. 1, the AGS 102 is configured to generate a first set (e.g., “x,” where x=5) of application designs (115A . . . 115x) using a first ML model (109). The AGS additionally generates a second set (e.g., “y,” where y=5) of application designs (117A . . . 117y) using a RAG subsystem 110 and a second ML model (e.g., ML model-2). Details related to the processing performed by the AGS 102 to generate the first set of application designs and the second set of application designs for an application is described in FIG. 2. The AGS 102 then evaluates the multiple application designs and selects a single application design that is deemed to be the “best” among the multiple application designs.

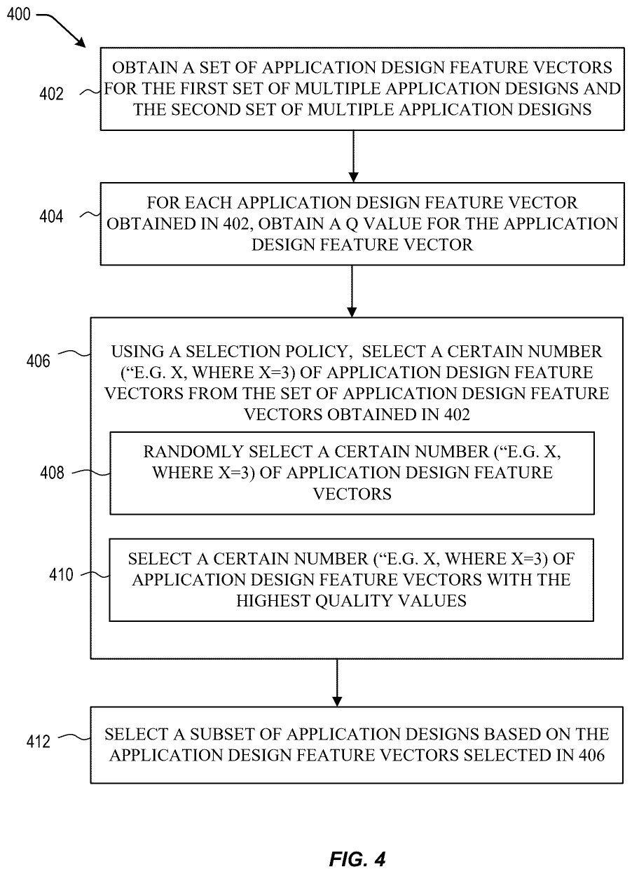

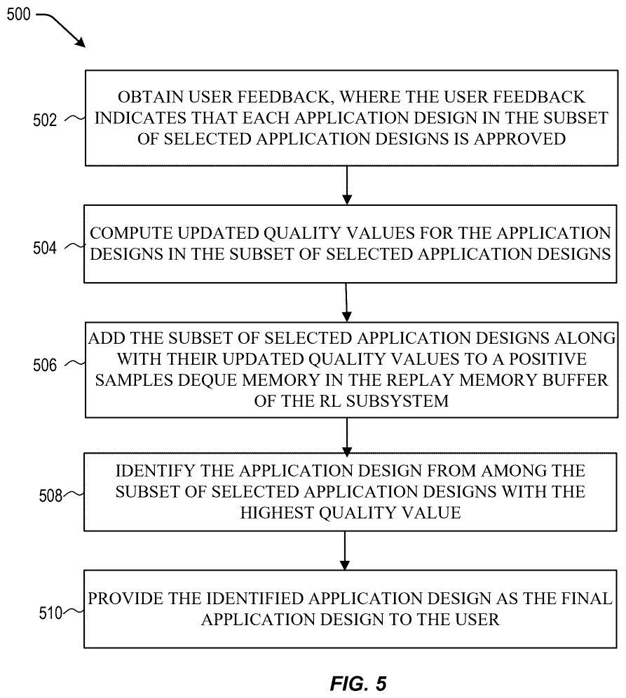

In certain embodiments, the evaluation of the multiple application designs is performed by a reinforcement learning (RL) subsystem 122 within the AGS 102. The RL subsystem 122 evaluates the multiple application designs by identifying and selecting a subset (e.g., “z”, where “z=5”) of application designs from among the first set of application designs and the second set of application designs. Details related to the processing performed by the RL subsystem 122 to identify and select a subset of application designs are described in FIGS. 4-5. The results of the processing performed by the RL subsystem 122 are communicated back to the requesting user and presented to the user via the AGS UI 106 in the user device 104. The results 132 may include the selected subset (e.g., the top “z”) application designs 138 that are identified and selected by the RL subsystem 122.

In certain examples, the selected subset of application designs 132 from the RL subsystem 122 may further be evaluated by a user of the AGS 102. For instance, the user may evaluate the selected subset of application designs by providing user feedback 134 regarding the selected subset of application designs via the UI 106 of the user device 104. The user feedback 134 may include information that identifies the user's approval or rejection of the application designs and can be provided by the user in text form via the UI 106. The user feedback 134 is further processed by a user feedback subsystem 136 in the AGS 102 and then transmitted to the

RL subsystem 122 for processing. The RL subsystem 122 analyses the user feedback 134 and based on the analysis selects a “single” application design that is deemed to be the “best” from among the subset of selected application designs. The selected (final) application design 138 is then transmitted back to the user via the UI 106 of the user device 104.

In certain examples, an application design (e.g., 138) that is generated for an application by the AGS can be comprised in a single application design document. In other examples, an application design for an application can be comprised in multiple documents. For instance, a first application design document can provide a detailed description of the functionality of the application, a second application design document can provide a description of the UI elements associated with the application, a third application design document can provide information identifying the database design and schema of the application and so on. Examples of various application design documents generated by the AGS 102 for an application are illustrated in the section entitled “Prompt Generation” below.

In certain embodiments, a user upon receiving the selected application design 138 from the RL subsystem 122 can provide confirmation (i.e., that indicates the user's approval) of the selected application design 138. The selected application design may then be transmitted by the AGS 102 to an application deployment system (not shown in FIG. 1) for deployment of the application. While not explicitly shown, it will be appreciated that the environment 100 may further include an application deployment system. Communications from the AGS 102 to the application deployment system may indicate the selected application design 138 and possibly information related to the selected application design. The application deployment system may include capabilities to generate and deploy a fully functional application based on the selected application design for use by the users of the AGS. Details related to the processing performed by the various systems and subsystems in FIG. 1 are described below with respect to the flowcharts depicted in FIGS. 2-10 and their accompanying description.

FIG. 2 depicts a simplified flowchart 200 depicting the processing performed by the AGS 102 shown in FIG. 1, according to certain embodiments. The processing depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 2 and described below is intended to be illustrative and non-limiting. Although FIG. 2 depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 2 may be performed by the ML models (109, 114), the RAG subsystem 110 and the RL subsystem 122 of the AGS 102 described in FIG. 1.

At block 202, the AGS 102 obtains user input 103 that identifies a set of application requirements for generating an application design for an application. As previously noted, the set of application requirements describe a set of features related to the application, a description of the attributes of the application, a description of the pages in the application, the logic (workflows, algorithms) for generating the application and so on. An example of an application requirement document that identifies a set of application requirements for generating an application design for an application is described in FIG. 3.

FIG. 3 is an example illustration of an application requirement document that identifies a set of application requirements for generating an application design for an application, in accordance with certain embodiments. The following non-limiting example is used to describe an application requirement document for a consumer goods application. The application requirement document described in FIG. 3 is merely an example and not intended to unduly limit the scope of claimed embodiments. One of ordinary skill in the art would recognize many possible variations, alternatives, and modifications. For example, in some implementations, the application requirement document can identify a set of application requirements for generating an application design for a warranty application that manages warranty information related to vehicles and so on.

In certain examples, the set of application requirements in an application requirement document 300 can be described in multiple sections (e.g., an application requirement section 302, a feature description section 304, an objects description section 306, a pages description section 308 and a logic description section 310). Details of the information described in each of these sections of the document is described below:
(a) Application requirement section: This section specifies information related to the type of application to be generated. For instance, this section can specify that the type of application to be generated is a consumer goods application which manages customers, inventories and so on.
(b) Feature description section: This section describes a set of features to be implemented in the application design for the application. For instance, the following features may be identified for an application design for a consumer goods application:
   (1) The application is for the consumer goods industry
   (2) Only authenticated users should be able to access the application
   (3) The application should be accessible via Desktop and Mobile Phones
(c) Objects Description Section: This section describes a set of objects, the description of the objects and the attribute information related to the objects to be implemented in the application design for the application. The attribute information may additionally specify the datatype of each attribute of the object. For instance, the following objects may be identified for the application design for a consumer goods application:
   (1) Object Name: CUSTOMER
   Object Description: Holds customer details
   Object Attribute info: {email id, customer id, loyalty status, name, phone number}
   (2) Object Name: INVENTORY
   Object Description: Holds inventory details
   Object Attribute info: {inventory id, quantity of inventory}
   (3) Object Name: ORDER
   Object Description: Holds order details
   Object Attribute info: {order id, product id, quantity, amount}
(d) Pages Description Section: This section describes a set of pages to be implemented in the application design for the application. For instance, the following pages may be identified for an application design for a consumer goods application:
   (1) Customer page to create and edit customers
   (2) Customer search page to search for customers
   (3) Customer inventories page to manage inventory
   (4) Customer orders page to manage orders and order details
(e) Logic description section: This section describes the logic (workflows, algorithms) required to build the application design for the application. For instance, this section may include information related to the workflows to be implemented in the application design for a particular page of the application. For example, for a consumer goods application, this section may include information related to the workflows to be implemented to determine and display a loyalty status (e.g., Gold, Silver, or Bronze) of a customer via a particular page (e.g., a customer list page) in the application.

The application requirement document depicted in FIG. 3 is an example and is not intended to be limiting in any manner. The various sections of the application requirement document are for illustrative purposes only and is not intended to be restrictive or limiting. In alternate embodiments, the application requirement document 300 can have more or fewer sections describing the various functional aspects and non-functional aspects of the application design. In the embodiment depicted in FIG. 3, the set of application requirements are described in an application document. In other embodiments, the set of application requirements can be directly provided by a user in the form of a text fragment via the UI of the user device as described in FIG. 1.

Returning to the discussion of FIG. 2, at block 204, the AGS 102 generates a first set of multiple application designs for the user input received in 202. In certain implementations, the first set of application designs (application design-1 115A . . . application design-x 115X) are generated by the AGS 102 using a first ML model (ML model-1 109) and a set of one or more prompts 108, where the set of prompts are generated based on the user input 103. In certain examples, the set of prompts are generated by a prompt generator 107 in the AGS 102 and provided as inputs to the ML model (e.g., ML model-1 109) which then produces multiple, varied outputs (i.e., a first set of application designs for an application) based on the set of prompts. Details related to prompt generation and prompt generation techniques used by the prompt generator 107 to generate a set of prompts are described in detail in the section titled “Prompt Generation.”

At block 206, the AGS 102 generates a second set of multiple application designs for the user input received in 202. The processing described in block 206 can be performed in parallel or can be performed sequentially after the processing performed in block 202. The second set of multiple application designs (app design-1 117A . . . app design-x 117Y) are generated by the AGS 102 using a combination of RAG techniques and a second ML model (ML model-2 114). The processing performed by the AGS 102 to generate a second set of multiple application designs comprises multiple stages. In a first stage, at block 208, the AGS 102 uses a RAG subsystem 110 to identify and retrieve a set of relevant application designs (113A . . . 113Y) for the user input 202. The set of relevant application designs are identified by the RAG subsystem 110 using RAG techniques by searching a corpus of application designs stored in a RAG vector database 112. The corpus of application designs comprise a repository of domain-specific and industry-specific application designs. As a result of the processing performed at block 208, the RAG subsystem 110 may select a top “y” (e.g., where y-5) relevant application designs that match the user input from the RAG vector database 112. In a second stage, at block 210, the AGS 102 uses a second ML model (e.g., ML model-2 114), the set of relevant application designs obtained from the RAG system and a set of one or more prompts 108 to generate a second set of multiple application designs (e.g., 117A . . . 117Y) for the application. The set of prompts 108 may be generated by the prompt generator 107 based on the user input and provided as inputs to the ML model (e.g., ML model-1 109) along with the set of relevant application designs 113. The ML model 109 analyzes the set of relevant application designs 113 and the set of prompts 108 to produce the second set of application designs for the application.

### Prompt Generation

As previously noted, a prompt generator 107 in the AGS 102 may be configured to generate a set of prompts that may be used by the ML models (e.g., 109, 114) to produce multiple, varied outputs (i.e., multiple variations of application designs) for an application to be generated. In certain examples, and as depicted in FIG. 1, the set of prompts 108 may be generated based on the user input 103, where the user input identifies a set of application requirements for an application design. The set of prompts are used to provide intent and contextual information to the ML models (109, 114) that the ML models can use or reference when generating a desired output (i.e., an application design). For instance, a set of prompts 108 that are generated by the prompt generator based on the user input 103 may provide information related to the layout and structure of the application design, identify specific UI elements to be added to the application design (e.g., navigation bar, dropdown menu and so on), specify the visual aspects of the application design like background color or font styles and so on, include information related to the formats (e.g., JSON) of the tables and text to be part of the application design, specify certain operations to be performed by the functions defined in the application and so on. Examples of prompts and application designs that are generated by the ML models based on a set of prompts are described below.

The first example shown below illustrates an example of a prompt that can be generated by the prompt generator based on user input identifying a set of application requirements. The prompt can be provided to the ML models to generate an application design for an application.

### Prompt Example-1

“Generate an application design for a warranty management application that includes a set of objects with valid sets of fields for each object identified in the user input.”

### Application Design Generated Based on Prompt Example-1

class customer (models.Model):
name = models.CharField(_(‘Name’), max_length=100)
description = models.TextField(_(‘Description’), blank=True, null=True)
manufacturer = models.CharField(_(‘Manufacturer’), max_length=100)
model_number = models.CharField(_(‘Model Number’), max_length=50)
serial_number = models.CharField(_(‘Serial Number’), max_length=50)
purchase_date = models.DateField(_(‘Purchase Date’))
warranty_period = models.PositiveIntegerField(_(‘Warranty Period (months)’), default=12)
def _{——}str_{——}(self)

The second example shown below illustrates another example of a prompt that can be generated by the prompt generator based on user input identifying a set of application requirements. The prompt can be provided to the ML models to generate an application design for an application.

### Prompt Example-2

“Create CRUD operations (views.py), forms (form.py), and HTML templates for the objects identified in the user input.”

### Application Design Generated Based on Prompt Example-2

def product_list(request):
products = Product.objects.all( )
return render(request, ‘product_list.html’,
{‘products’: products})
def product_detail(request, pk):
product = get_object_or_404(Product, pk=pk)
return render(request, ‘product_detail.html’,
{‘product’: product})
def product_create(request):
if request.method == ‘POST’:
form = ProductForm(request.POST)
if form.is_valid( ):
form.save( )
return redirect(‘product_list’)
else:
form = ProductForm( )
return render(request, ‘product_form.html’, {‘form’: form})
def product_update(request, pk):
product = get_object_or_404(Product, pk=pk)
if request.method == ‘POST’:
form = ProductForm(request.POST, instance=product)
if form.is_valid( ):
form.save( )
return redirect(‘product_list’)
else:
form = ProductForm(instance=product)
return render(request, ‘product_form.html’, {‘form’: form})
def product_delete(request, pk):
product = get_object_or_404(Product, pk=pk)
if request.method == ‘POST’:
product.delete( )
return redirect(‘product_list’)
return render(request, ‘product_confirm_delete.html’,
{‘product’: product})

The third example shown below illustrates yet another example of a prompt that can be generated by the prompt generator based on user input identifying a set of application requirements. The prompt can be provided to the ML models to generate an application design for an application:

### Prompt Example-3

“Create urls to define URL patterns and link CRUD operations for the application based on the objects identified in the user input.”

### Application Design Generated Based on Prompt Example-3

urlpatterns = [
# Product URLs
path(‘products/’, views.product_list, name=‘product_list’),
path(‘products/<int:pk>/’, views.product_detail, name=‘product_detail’),
path(‘products/add/’, views.product_create, name=‘product_create’),
path(‘products/<int:pk>/update/’, views.product_update, name=‘product_update’),
path(‘products/<int:pk>/delete/’, views.product_delete, name=‘product_delete’),
# Customer URLs
FlexiForge - The Generative Application Builder 28
# Add URLs for Customer CRUD operations here
# Warranty URLs
# Add URLs for Warranty CRUD operations here
]

There are various ways in which the prompt generator 107 can generate a set of prompts. In some instances, the prompt generator may utilize an iterative prompting technique to generate a set of prompts. In this approach, the prompt generator 107 is configured to perform a certain number of iterations to generate a set of prompts. For instance, using this approach, in a first iteration, the prompt generator 107 may generate a prompt and obtain a response from the ML model based on the prompt. The prompt generator may then refine the response obtained from the ML model through subsequent prompts and repeat the process of generating prompts for a certain number of iterations to generate a set of responses from the ML model. In another approach, the prompt generator may utilize a non-iterative prompting technique to generate a set of prompts. In this approach, the prompt generator may be configured to simultaneously generate a set of prompts, where each prompt is a variant of the other and provide the set of prompts to the ML model. The set of prompts that can be used by the ML model (e.g., ML model-1 109 and ML model-2 114) to simultaneously produce multiple, varied outputs (e.g., multiple application designs) for an application.

Returning to the discussion of FIG. 2, at block 212, the AGS 102 selects a subset of application designs from the first set of multiple application designs and the second set of multiple application designs based on a set of quality values related to the application designs. In certain implementations, the quality values (also referred to herein as Q-values) are generated by the Reinforcement Learning (RL) subsystem 122 in the AGS 102 by evaluating a set of application design features related the application designs in the first set of application designs and the second set of application designs. Details related to the generation of quality values for application designs related to an application and the evaluation and the selection of a subset of application designs based on the quality values is described in detail in FIGS. 4 and 5.

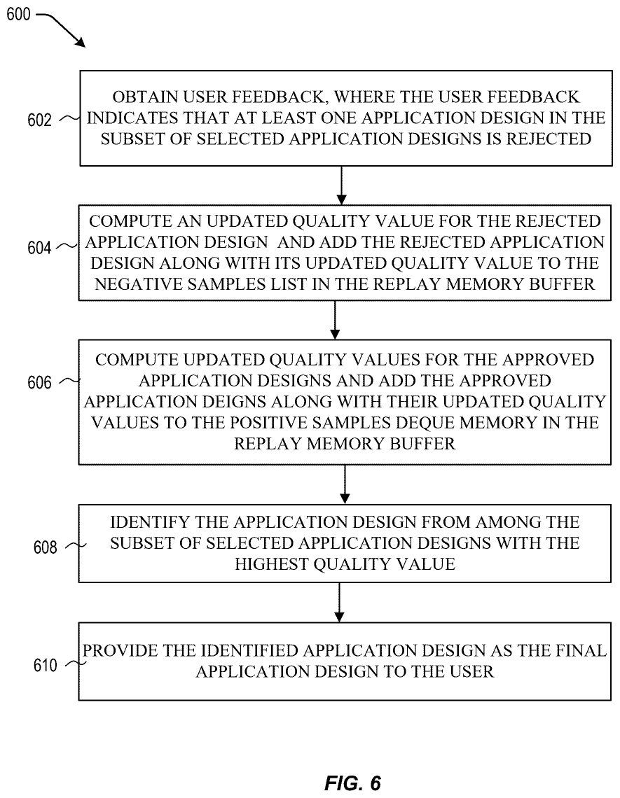

At block 214, the AGS 102 provides the subset of selected application designs to user of the AGS for further evaluation. In certain embodiments, the AGS obtains user feedback regarding the application designs in the subset of selected application designs. The user feedback is received by a user feedback subsystem in the AGS and then transmitted to the RL subsystem for further evaluation. The RL subsystem evaluates the user feedback and based on the evaluation, selects a “final” application design for the application from among the subset of selected application designs and transmits the “final” application design to the user. The “final” application design is provided to the user via the UI of the user device. Additional details of the interactions between the user, the user feedback subsystem 136 and the RL subsystem 122 in the AGS 102 for evaluating the multiple application designs and then selecting a final application design that is deemed to be the “best” from among the multiple application designs is described in FIGS. 6-8 below.

Application Design Evaluation and Application Design Selection using Feature Extraction and Reinforcement Learning

In certain embodiments, as described in FIG. 2, the multiple application designs (e.g., 115A . . . 115X) and (e.g., 117A . . . 117Y) generated using a combination of ML models and RAG techniques as described in FIG. 1 are provided to the RL subsystem 122 in the AGS 102 for evaluation. The RL subsystem 122 evaluates the multiple application designs, and based on the evaluation, identifies and selects a subset of application designs from among the multiple application designs based on a set of quality values related to the application designs. In certain implementations, the quality values (also referred to herein as Q-values) are generated by the Reinforcement Learning (RL) subsystem 122 in the AGS 102 using the concept of reinforcement learning (RL) and by evaluating a set of application design features related the application designs in the first set of application designs and the second set of application designs.

Reinforcement Learning (RL) refers to a type of machine learning that is focused on making decisions to maximize cumulative rewards in a given situation. In RL, an agent (e.g., an ML algorithm) learns to achieve a goal in an uncertain, potentially complex environment by performing actions and receiving feedback through rewards or penalties. The agent takes actions within the environment, receives rewards or penalties, and adjusts its behavior to maximize the cumulative reward. The RL learning process is typically characterized by the following elements:
(1) Policy: A strategy used by the agent (the learner or decision maker) to determine the next action based on the current state (a specific situation in which the agent finds itself).
(2) Reward Function: A function that provides a scalar feedback signal based on the state and action (all possible moves the agent can make).
(3) Q-value: A quality function (also referred to as a Q function) that represents the value of taking a specific action in a particular state. The Q-value is an estimate of the expected cumulative reward (feedback from the environment based on the action taken) from a given state.

FIG. 4 depicts a simplified flowchart 400 depicting the processing performed by the RL subsystem in the AGS 102 shown in FIG. 1 to identify and select a subset of application designs for an application from among multiple application designs, according to certain embodiments. The processing depicted in FIG. 4 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 4 may be performed by the feature vectorization subsystem 116 and the RL subsystem 122 of the AGS 102 described in FIG. 1.

At block 402, the RL subsystem 122 obtains a set of application design feature vectors (118A . . . 118X) and (120A . . . 120Y) related to the application designs in the first set of multiple application designs (115A . . . 115X) and the second set of multiple application designs (117A . . . 117Y) respectively. An application design feature vector related to an application design may include information related to one or more relevant features of the application design. An application design feature vector may be represented as a numerical representation of a set of features related to the application design. In certain implementations, the set of application design feature vectors are generated by a feature vectorization subsystem 116 in the AGS 102 by identifying and extracting relevant features related to the application designs. Examples of various features that may be identified and extracted by the feature vectorization subsystem are described below:
(1) Design complexity: This feature indicates the level (e.g., low, medium, high) of design complexity that a user prefers while generating an application design. This feature may be captured by the feature vectorization subsystem 116 from the user input 103. For instance, the user can indicate the level (easy, medium, hard) of design complexity as part of the user input 103 provided to the AGS.
(2) Sentence Embedding: This feature captures the semantic meaning of the user input 103 based on a set of prompts that are generated based on the user input.
(3) Cosine Similarity: This feature captures the similarity of a set of prompts generated by the prompt generator to the set of application designs output by the ML models.
(4) Length of the prompts: This feature captures the length of the prompts provided to the ML models.
(5) Jaccard Similarity: This feature calculates the size of the intersection of the sets that represent the presence or absence of words in the user input or in the set of relevant design documents retrieved by the RAG system divided by the size of their union.
(6) Number of Tables and average number of columns per table: This feature measures complexity of application designs that are identified and retrieved by the RAG subsystem.
(7) Number of Application pages: This feature may be extracted from the user input or from one or more relevant application designs extracted by the RAG subsystem. For instance, this feature may capture the complexity of the application's design.

At block 404, the RL subsystem obtains a quality value (Q-value) for each application design feature vector obtained in 402. As noted above, the “Q-value” represents the value of taking a specific action in a particular state and provides an estimation of an expected future reward that can be obtained by starting at that state and taking the action in that state. For instance, in the context of evaluating application designs, a “state” may correspond to a particular observation of an application design feature vector related to the application design, an “action” may correspond to a move (“approve,” “reject′) associated with a particular application design that is taken by the agent, the “reward” may correspond to a signal that is updated when the “action” taken by the agent matches a target label (e.g., “approve” or “reject”) that is received via user feedback from a user of AGS and the “Q-value” represents the value (reward) obtained by selecting a specific action (i.e., “approving” or “rejecting” an application design) for a particular state (i.e., an application design feature vector) related to the application design. In other words, a Q-value represents a value that is obtained as a result of selecting (or not selecting) a particular application design from among the first set of application designs and the second set of application designs

In a certain implementation, the Q-values for the application design feature vectors may be determined by a Deep Q Network (DQN) 130 within the RL subsystem 122. The DON 130 comprises a deep neural network that uses a Q-learning algorithm (which is a type of reinforcement learning algorithm) to determine the next possible best action to take based on a current state. Q-learning refers to a trial-and-error reinforcement learning process where an agent learns through repeated interactions with its environment. In the “Q-learning” approach, an “action-value” function (or alternatively, a “Q-function”) is used to determine the “value” of being at a particular state and taking a specific action in that state. The “Q” value is a metric that measures the “Quality” of that action in that state and represents how valuable an action is in maximizing future rewards. In reinforcement learning, a Q-value equation may typically be represented as shown below:

$$Q ( s , a ) = R ( s , a ) + γ * max ( Q ( {s}^{′} , {a}^{′} ) ) ;$$

where Q(s, a) represents the estimated value of taking action “a” in state “s”, R(s, a) is the immediate reward received for taking that action, y is the discount factor, and “max (Q (s′, a′))” represents the maximum possible Q-value in the next state “s” across all possible actions “a”.

Initially, the DON is created with a set of random weights to determine an initial set of Q-value estimates for each possible action that can be taken for a given state. The DQN takes a “state” as input and outputs a set of Q-values for all possible actions that can be taken from that state. The DON determines (estimates) different Q-values for each possible action that can be taken for a given state to increase (maximize or improve) a cumulative future reward.

At block 406, the RL subsystem uses a selection policy to select a certain number (e.g., Z, where Z=3) of application design feature vectors from among the set of application design feature vectors obtained in 402 based on the Q-values obtained in block 404. The selection policy determines the particular action to take in each state based on the estimated Q-values. In a certain implementation, the RL subsystem 122 uses a selection policy that is based on an epsilon-greedy action selection strategy to select the particular action to take for each state. Using the epsilon-greedy action selection strategy, the agent can either choose random actions to discover new strategies (exploration) or choose actions based on accumulated knowledge (exploitation). For instance, in certain approaches, the agent may utilize an epsilon-greedy action selection technique that is based on exploration to randomly select a certain number (e.g., z, where z=3) of application design feature vectors (i.e., states) along with their corresponding Q-values by randomly selecting a set of actions corresponding to the set of states, where the set of states correspond to a set of application design feature vectors. In other approaches, the agent may utilize an epsilon-greedy action selection technique that is based on exploration to select the top “z” (e.g., where z=3) application design feature vectors with the highest Q values by selecting the top “z” actions having the highest Q values.

At block 412, the RL subsystem selects a subset of application designs based on the application design feature vectors selected in 406. The subset of application designs are selected by identifying the application designs that relate (map) to the application design feature vectors selected in 406. The RL subsystem then transmits the selected subset of application designs to a user of the AGS. The user can then provide user feedback regarding the selected subset of application designs. For instance, the user feedback 134 may include a “target label” that is indicative of whether an application design was “approved” or “rejected” by the user. The user feedback may be provided by a user of the AGS via a UI (e.g., 106) of a user device (e.g., 104) when the RL subsystem 122 transmits the selected subset of application designs to the user. In certain implementations, the user feedback 134 may be stored in a user feedback subsystem 136 in the AGS 102.

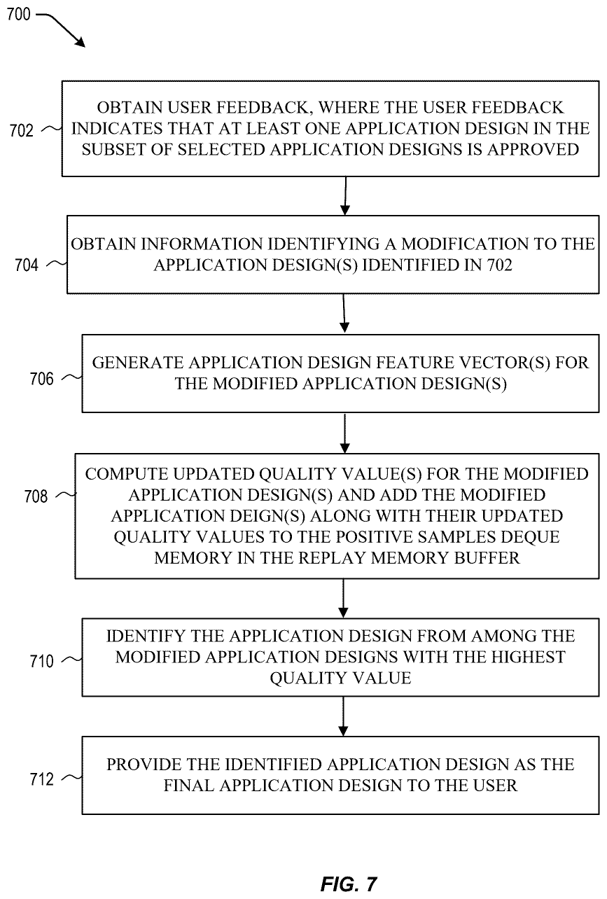

Using the experiences (i.e., the user feedback) gathered from the user regarding the selected subset of application designs, the agent in the DQN of the RL subsystem updates the Q-values for the selected application designs. The Q-values in the DQN are updated iteratively by the agent using the experiences (i.e., user feedback) gathered by the agent. The RL system then selects a single application design from among the selected subset of application designs based on the updated Q-values and transmits the selected application design to the user. In certain examples, and as described in FIG. 5 below, the user feedback may indicate that the user approved all the application designs from among the selected application designs. In some examples, and as described in FIG. 6, the user feedback may indicate that the user approved some of the application designs and rejected some others from among the selected application designs. In other examples, and as described in FIG. 7, the user feedback may indicate that the user rejected all the application designs from among the selected application designs. Additional details regarding the manner in with the DQN in the RL subsystem selects a single application design from among one or more application designs based on user feedback is described in detail in FIGS. 5-7 below.

FIG. 5 depicts a simplified flowchart 500 depicting the processing performed by the RL subsystem in the AGS 102 shown in FIG. 1 to select a single application design from among a selected subset of application designs based on user feedback, according to certain embodiments. The processing depicted in FIG. 5 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 5 and described below is intended to be illustrative and non-limiting. Although FIG. 5 depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 5 may be performed by RL subsystem 122 of the AGS 102 described in FIG. 1.

At block 502, the RL subsystem obtains user feedback, where the user feedback identifies that all the application designs from among the selected subset of application designs are approved. The user feedback 134 may be stored in a user feedback subsystem 136 in the AGS 102. In certain examples, the user feedback may include a “target label” that is indicative of whether an application design was “approved” or “rejected” by the user. As previously described, the user feedback may be provided by a user of the AGS via a UI (e.g., 106) of a user device (e.g., 104) when the RL subsystem 122 transmits the selected subset of application designs (e.g., 132) to the user.

At block 504, the RL subsystem computes updated Quality values (i.e., Q-values) for all the application designs in the selected subset of application designs. As previously noted, the Q-value represents the cumulative reward for taking a particular action in a given state. In this case, since the action taken by the agent in the DQN of the RL system for all the given states (i.e., all the application designs in the selected subset of application designs identified as in 502) matches the user feedback (i.e., a target label that indicates that the user “approved” all the application designs) received from the user, the agent computes a reward and updates the Q values for the application designs based on the reward.

In a certain implementation, an updated Q-value (Qnew) for an application design can be computed by the RL subsystem as shown in equation (1) below:

$$Qnew = Qold + α [ Reward - Qold ] \qquad ( 1 )$$

where, Qnew is the updated Q-value for a state S, Qold is the current Q-value in memory for the state S, α is the learning rate, which determines how much the reward impacts the current Q-value and reward is a scalar value representing the positive reinforcement for the decision associated with Qold, A higher reward increases the Q-value, higher encouraging of the state-action combination of accepted designs.

If the model predicts a high Q-value for the state S and the outcome was desirable (rewarded), the Q-value increases proportionally, making it more likely to be selected in future iterations. Lower Q-values, which signify rejection, will increase with a reward, allowing the model to reevaluate and potentially promote such states for future decisions.

At block 506, the RL subsystem adds all the application designs identified in 502 along with their updated Q-values to a positive samples deque memory in a dual replay memory buffer 131 of the DON in the RL subsystem. Additional details of the implementation of the dual replay memory buffer in the DQN 130 is described in the section titled “Training the DQN” below.

At block 508, the RL subsystem identifies the application design from among the selected subset of application designs stored in the dual replay memory buffer that has the highest Q-value.

At block 510, the RL subsystem transmits the selected application design to the user. The selected application design is displayed to the user via a UI (e.g., 106) of a user device (e.g., 104).

FIG. 6 depicts a simplified flowchart 600 depicting the processing performed by the RL subsystem in the AGS 102 shown in FIG. 1 to select a single application design from among the selected application designs based on user feedback, according to certain embodiments. The processing depicted in FIG. 6 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 6 and described below is intended to be illustrative and non-limiting. Although FIG. 6 depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 6 may be performed by RL subsystem 122 of the AGS 102 described in FIG. 1.

At block 602, the RL subsystem obtains user feedback, where the user feedback identifies that at least one the application design from among the selected application designs is rejected.

At block 604, the RL subsystem computes an updated Q-value for the rejected application design identified in 602 and adds the rejected application design along with its updated Q-value to a negative samples deque memory in the replay memory buffer. In this case, the action (“approved” application design) taken by the agent in the DQN of the RL system for the given state (i.e., the application design identified in 602) does not match the user feedback (i.e., a target label that indicates that the user “rejected” the application design) received from the user, the agent computes a penalty and updates the Q-value based on the penalty. Additional details of the implementation of the dual replay memory buffer in the DQN 130 is described in the section titled “Training the DQN” below.

In a certain implementation, the RL subsystem updates the Q value based on a penalty value using equation (2) shown below:

$$Qnew = Qold + α [ Penalty - Qold ] \qquad ( 2 )$$

where, Qnew is the updated Q-value for the state S, Qold is the current Q-value in memory for the state S, α is the learning rate, which determines how much the penalty affects the current Q-value and the penalty is a scalar value representing the negative impact for the decision associated with Qold. A higher penalty reduces the Q-value of the rejected application designs.

If the model predicts a high Q-value for S, and the outcome was undesirable (penalized), the Q-value decreases proportionally, making it less likely to be selected in future iterations. Lower Q-values already signify rejection, so the penalty would further reduce them, ensuring consistent reinforcement.

At block 606, the RL system computes updated Q-values for the approved application designs identified in 602 and adds the approved application deigns along with their updated Q-values to the positive samples deque memory in the replay memory buffer. For the approved application designs, the action taken by the agent in the DQN of the RL system for the given states (i.e., the approved application designs identified in 602) matches the user feedback (i.e., a target label that indicates that the user “approved” these application designs) received from the user, and the agent computes a reward and updates the Q-value based on the reward.

At block 608, the RL subsystem identifies the application design from among the selected application designs stored in the dual replay memory buffer that has the highest Q-value.

At block 610, the RL subsystem transmits the selected application design to the user. The selected application design is displayed to the user via a UI (e.g., 106) of a user device (e.g., 104).

FIG. 7 depicts a simplified flowchart 700 depicting the processing performed by the RL subsystem in the AGS 102 shown in FIG. 1 to select a single application design from among the selected application designs based on user feedback, according to certain embodiments. The processing depicted in FIG. 7 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 7 and described below is intended to be illustrative and non-limiting. Although FIG. 7 depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 7 may be performed by RL subsystem 122 of the AGS 102 described in FIG. 1.

At block 702, the RL subsystem obtains user feedback, where the user feedback identifies that at least one application design from among the selected subset of application designs is approved. As noted above, the user feedback 134 may be stored in a user feedback subsystem 136 in the AGS 102.

At block 704, the RL subsystem obtains information that identifies a modification to the application design(s) identified in 702. The modification to the application design(s) can be identified as part of user feedback received from the user. For instance, a modification to the application design may include a modification to a description of the attributes related to the application, a modification to a page description in the application or a modification to the process flows implemented the application.

At block 706, the RL subsystem transmits the information identifying the modifications to be made to the application design(s) to the feature vectorization subsystem 116 in the AGS. The feature vectorization subsystem 116 generates modified application design feature vector(s) for the application design(s) identified in 702 by identifying and extracting features related to the modified application design(s). The modified application design feature vector(s) are then stored by the feature vectorization subsystem for future processing by the RL subsystem.

At block 708, the RL subsystem computes updated Quality values (Q-values) for the identified modified application design(s) and adds the identified modified application design(s) along with their updated Q-values to a positive samples deque memory in a dual replay memory buffer 131 of the DON in the RL subsystem.

At block 710, the RL subsystem identifies the application design from among the modified application designs stored in the dual replay memory buffer that has the highest Q-value.

At block 712, the RL subsystem transmits the modified application design to the user. The selected application design is displayed to the user via a UI (e.g., 106) of a user device (e.g., 104).

Training the Reinforcement Learning (RL) subsystem

As noted above, the RL subsystem may include capabilities to iteratively update the Q-values associated with the application designs based on experiences (i.e., the user feedback) gathered by the agent. In certain implementations, the DQN 130 in the RL subsystem 122 may be regularly trained using experiences from both positive and negative samples that are stored in the dual replay memory buffer 131 of the RL subsystem. This training enhances the DQN's ability to accurately predict and recommend application designs that align with user preferences (i.e., user feedback). The observed experiences may be stored in the form of experience tuples (state, Q-value) in the dual replay memory buffer and the DQN 130. The DQN may be trained on random mini-batches of these observed experiences from the buffer. In the training phase, a small batch of tuples are randomly selected, and the agent learns from this selected batch of tuples to create and update the weights of the DQN 130 to get a better approximation of the Q-values. The dual replay memory buffer 131 in the DON 130 can be used to make more efficient use of experiences obtained from the agent as a result of the agent's interaction with its environment. The dual replay memory buffer 131 enables agents to remember and reuse past experiences that can be used by the agent during the training process, thereby improving the efficiency of the training process of the DQN.

The Deep Q-Learning training process comprises (1) an initialization phase and (2) a sampling and training phase. In the initialization phase, the DQN is created with random weights and the dual replay memory buffer along with its positive samples deque memory and negative samples deque memory are initialized. In the sampling and training phase, a set of actions are selected using a selection policy as described above and the agent determines the action to take based on the user feedback. In certain examples, at a high level, the training process performed by the DQN involves the following steps:
(1) Load a set of application design feature vectors: In this step, the agent obtains data pertaining to a set of the available states {S1, S2, S3, . . . . Sn} of the environment. For instance, in the context of application design generation, the set of states correspond to a set of application design feature vectors related to a set of application designs.
(2) Select Action: In this step, the agent uses a selection policy to determine the particular action to take in each state based on the Q-values computed by the DQN. In a certain implementation, the RL subsystem 122 may utilize an epsilon-greedy action selection technique that is based on exploration to randomly select a certain number (“e.g., z, where z=3) of application design feature vectors (i.e., states) along with their corresponding Q-values by randomly selecting a set of actions corresponding to the set of states, where the set of states correspond to a set of application design feature vectors. In other approaches, the RL subsystem may utilize an epsilon-greedy action selection technique that is based on exploration to select the top “z” (e.g., where z=3) application design feature vectors with the highest Q values by selecting the top “z” actions having the highest Q values.
(3) Take Action: In this step the agent determines the particular action to take based on the Q-value and the reward.
(4) Store Experiences: In this step the agent saves a set of experiences in the replay memory buffer. The data associated with each (training) iteration may be stored in either the positive samples deque memory or the negative samples deque memory in the replay memory buffer.
(5) Sample and Train: If both the positive samples deque memory and the negative samples deque memory have enough samples, the agent samples a batch of experiences equally from the positive samples deque memory and the negative samples deque memory along with State S (new experience). The agent then updates the DQN by computing new Q-values and the process is repeated.
   Prompt Modification based on Application Design Schema Quality Score

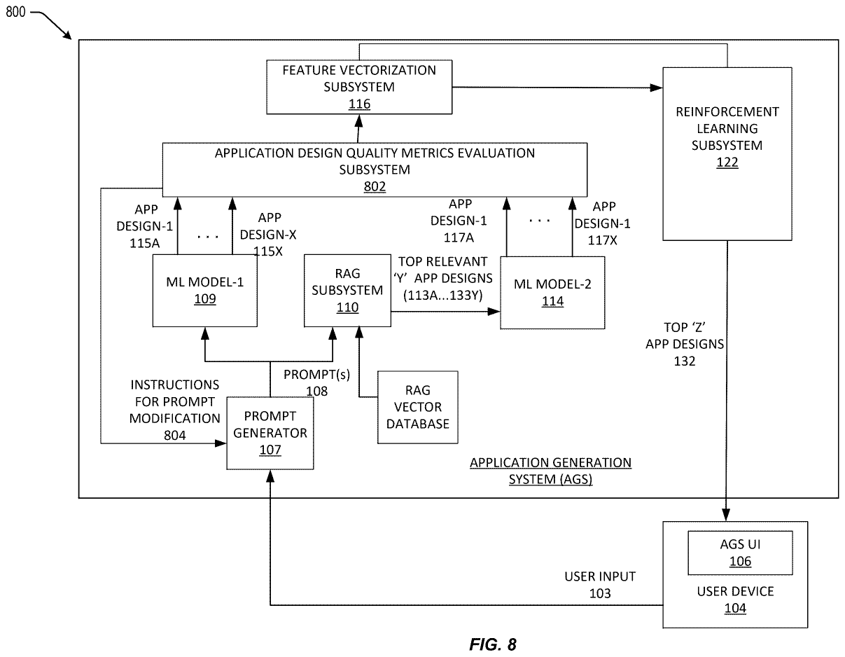

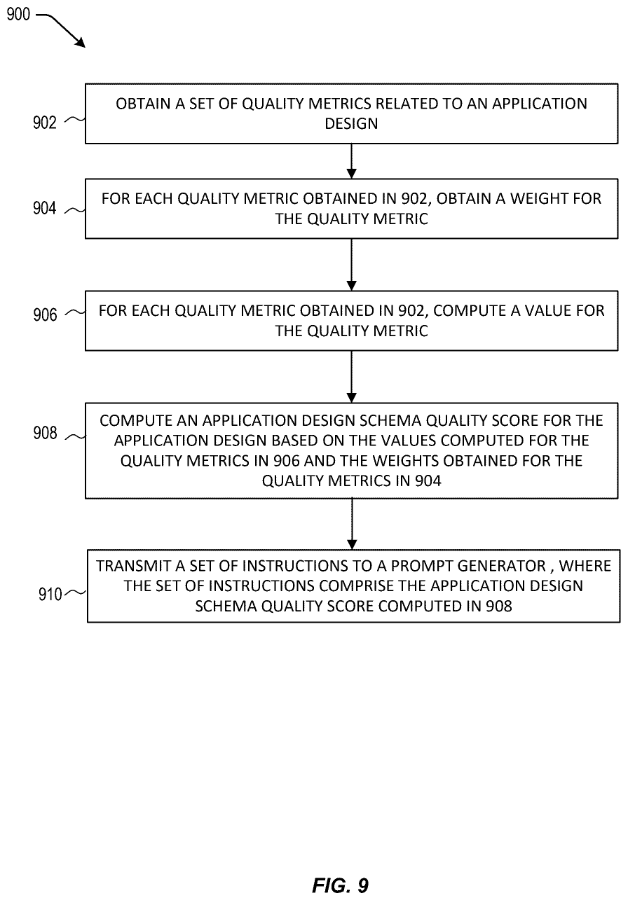

In certain embodiments, the first set of application designs (e.g., 115A . . . 115X) and the second set of application designs (e.g., 117A . . . 117Y) that are generated using a combination of ML models (109, 114) and the RAG subsystem (112) as described above are first evaluated by an application design quality metrics evaluation subsystem 802 in the AGS 102 prior to being evaluated for selection by the RL subsystem 122. In certain examples, the application design quality metrics evaluation subsystem 802 measures the quality of the application designs by computing a schema quality score for the application designs. The schema quality score is computed by the application design quality metrics evaluation subsystem 802 by assessing various quality metrics that relate to the quality of the schema of an application design. By using a schema quality score as a guiding metric, the quality of the application designs can be evaluated by the AGS 102 to ensure that the application designs effectively meet both functional requirements as well as quality standards. Details related to the processing performed by the application design quality metrics evaluation subsystem 802 to evaluate the quality of the application designs are described in FIG. 8 and FIG. 9 below.

FIG. 8 depicts an example of a computing environment 800 comprising an application generation system (AGS) 102 that includes an application design quality metrics evaluation system for evaluating the quality of an application design generated for an application, according to certain embodiments. The AGS system 102 may be implemented using one or more computing systems. For example, the computing systems may execute computer-readable instructions (e.g., code, program) to implement the AGS system 102. As depicted in FIG. 1, the AGS system 102 includes various computing systems such as a prompt generator 107, one or more machine learning models (e.g., 109, 114), a Retrieval Augmented Generation (RAG) subsystem 110, an application design quality metrics evaluation subsystem 802, a feature vectorization subsystem 116 and a reinforcement learning (RL) subsystem 122. The systems and subsystems depicted in FIG. 1 may be implemented using only software (e.g., code, instructions, program) executed by one or more processing units (e.g., processors, cores) of a computing system, hardware, or combinations thereof. The software may be stored on a non-transitory storage medium (e.g., on a memory device).

In certain implementations, and as depicted in the embodiment shown in FIG. 8, the AGS 102 may be configured to receive a set of application requirements for generating an application design for an application. For instance, a user of the AGS 102 can request the AGS 102 to generate an application design for an application by providing a user input 103 (e.g., via a AGS UI 106 of a user device 104) that identifies a set of application requirements for generating an application design for the user input. The user input 103 can be provided by the user in text form (e.g., by typing in sentence(s) or a text fragment that identifies a set of application requirements related to the application) or by providing an application requirements document as described in FIG. 1.

The AGS 102 may then be configured to perform a series of processing steps based on the user input. These processing steps may include, for example, converting the user input into a set of prompts that are analyzed by a set of Artificial Intelligence (AI) agent(s) using a combination of machine language (ML) techniques and retrieval augmented generation (RAG) techniques and receiving a set of responses (e.g., one or more application designs generated for the application) from the AI agent(s) based on the set of prompts. In certain embodiments, the AGS 102 includes capabilities to generate multiple application designs for an application (user input) using a combination of ML models and RAG techniques. As noted above, the AGS 102 may utilize various types of ML models, such as language models (e.g. BERT) and large language models (LLMs) such as GPT-4 to generate multiple application designs simultaneously for an application. For instance, as shown in the embodiment depicted in FIG. 8, the AGS 102 may be configured to generate a first set (e.g., “x,” where x=5) of application designs (115A . . . 115x) using a first ML model (109). The AGS may additionally be configured to generate a second set (e.g., “y,” where y=5) of application designs (117A . . . 117y) using a RAG subsystem 110 and a second ML model (e.g., ML model-2).

In certain examples, the multiple application designs generated by the AGS 102 are provided to an application design quality metrics evaluation subsystem 802 for evaluation. The application design quality metrics evaluation subsystem 802 includes capabilities to evaluate the quality of the generated application designs by computing schema quality scores for the application designs. The schema quality score for an application design is computed by (1) identifying various quality metrics related to the application design (2) assigning a weight to the quality metrics and (3) computing values for the quality metrics. Additional details of the processing performed by the application design quality metrics evaluation subsystem 802 to compute schema quality scores for generated application designs is described in FIG. 9.

By using a schema quality Score as a guiding metric to evaluate the quality of the generated application designs, the users of the AGS can systematically enhance the quality of the designs and ensure that the designs meet both functional requirements as well as quality standards. In certain approaches and as described in FIG. 9 below, the schema quality scores generated by the application design quality metrics evaluation subsystem 802 may be processed by the prompt generator 107 in the AGS. The prompt generator may be configured to use the schema quality scores to generate a modified set of prompts. The modified set of prompts can be used to iteratively enhance the application designs that are generated using the combination of ML models and RAG techniques as described above.

FIG. 9 depicts a simplified flowchart 900 depicting the processing performed by the application design quality metrics evaluation subsystem in the AGS 102, according to certain embodiments. The processing depicted in FIG. 9 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 9 and described below is intended to be illustrative and non-limiting. Although FIG. 9 depicts the various processing steps occurring in a particular sequence or order, this is not intended to be limiting. In certain alternative embodiments, the processing may be performed in some different order, or some steps may also be performed in parallel.

In certain embodiments, the processing depicted in FIG. 9 may be performed by the application design quality metrics evaluation subsystem 802 for each application design in the first set of application designs and the second set of application designs.

At block 902, the application design quality metrics evaluation subsystem 802 obtains a set of quality metrics related to an application design. The set of quality metrics may be pre-defined by a user (e.g., a schema designer) of the AGS 102 and stored in a datastore that is accessible to the application design quality metrics evaluation subsystem 802. In certain examples, each quality metric may be used to capture a specific aspect of a schema (e.g., a database schema) implemented by the application design. Examples of quality metrics that capture different aspects of a database schema related to the application design may include, but are not limited to:
(1) Number of Tables and Relationships: This quality metric identifies the number of tables and relationships defined in the schema design. A simpler application design may typically have fewer tables and clearly defined relationships, while a complex application design may have more tables and relationships with numerous joins.
(2) Clarity and Readability: This quality metric evaluates whether the purpose of each table, its columns, and the relationships between tables are easily understandable. A well-designed database schema should be intuitive and straightforward.
(3) Use of Appropriate Data Types: This quality metric ensures that each column employs suitable data types (e.g., integer for age, date for birthdate) enhances data integrity, and facilitates efficient querying.
(4) Number of Columns per Table: This metric directly correlates with schema complexity and maintenance efforts. Tables with a high number of columns can become unwieldy, leading to increased storage requirements and potentially slower query performance. Striving for a moderate number of columns (ideally between 5 to 10) per table enhances schema clarity and simplifies data management. It allows for more efficient querying and reduces the likelihood of redundancy or overly complex table structures.
(5) Number of Joins in Queries: This metric can significantly impact performance, especially in systems handling large datasets. Each join introduces additional processing overhead and potential latency. Minimizing the number of joins by designing tables with clear and optimized relationships helps improve query speed and scalability. Using appropriate normalization and denormalization techniques can reduce the need for complex joins thereby enhancing both query efficiency and schema maintainability.
(6) Foreign Key Complexity: This metric affects the schema design, affecting data integrity and system performance. Nested or circular foreign key dependencies can lead to maintenance challenges and potential inconsistencies. Designing foreign key relationships that are straightforward and necessary helps maintain data consistency and operational efficiency. Avoiding overly complex or unnecessary dependencies ensures that the schema remains robust and manageable over time, facilitating easier schema updates and modifications.

At block 904, the application design quality metrics evaluation subsystem 802 obtains a weight for each quality metric obtained in 902 for the identified application design. The weights may be pre-determined and assigned by a user of the application design quality metrics evaluation subsystem 802. Each metric may be assigned a weight based on its significance or priority in determining schema quality. Metrics with lower scores may indicate areas where the schema may be deficient or less optimized. The weighting ensures that critical factors have a proportionate influence on the overall quality score. For example, in certain instances, the normalization metric may be assigned a higher weight if data integrity and efficiency are important aspects of the overall score. Normalization is a systematic process used to standardize and organize data within a database. It involves structuring data to reduce redundancy and dependency, ensuring data integrity and efficiency in operations such as querying and updating.

The goal of normalization is to design a database schema that minimizes data redundancy and avoids anomalies during data manipulation. This process typically involves decomposing larger tables into smaller, related tables and defining relationships between them through keys. By adhering to normalization principles (usually categorized into different normal forms), databases can achieve optimal performance, scalability, and maintainability.

At block 906, the application design quality metrics evaluation subsystem 802 computes a value for each quality metric obtained in 902. For instance, for a quality metric such as the “Number of Tables and Relationships” in an application design, the value of the quality metric may identify the “number” of tables and relationships that are defined in the schema of the application design. The value for a quality metric that is computed for a particular application design may be specific to the application design. For instance, the number of tables and relationships that are defined in the schema of a first application design generated by a first ML model (109) may be different from the number of tables and relationships that are defined in the schema of a second application design generated by a second ML model (114).

At block 908, the application design quality metrics evaluation subsystem 802 computes an application design schema quality score for the application design based on the values computed for the quality metrics in 906 and the weights obtained for the quality metrics in 904. In one implementation, the schema quality score for an application design is determined by computing a weighted sum of the quality metrics as shown below:
Schema Quality Score for an application design=Σ(Weight_i*Metric_i) where “i” iterates over the identified quality metrics, Weight_i is the assigned weight for metric I and Metric_i is the calculated value for the quality metric i.

In certain examples, the schema quality score that is computed for an application is a numerical value (between 1-100). In certain implementations, the application design quality metrics evaluation subsystem 802 may additionally include capabilities to determine a “label” each application design based on the schema quality scores computed for the application design. For instance, if the schema quality score for an application design is in the range (90-100), application design may be labeled as having an “Excellent Schema Design,” if the schema quality score for an application design is in the range (80-89), application design may be labeled as having a “Good Schema Design,” if the schema quality score for an application design is in the range (70-79), the application design may be labeled as having an “Average Schema Design,” and if the schema quality score for an application design is below 70, the application design may be labeled as “Needs Improvement.”

At block 910, the subsystem 802 transmits a set of instructions to the prompt generator, where the set of instructions comprise the application design schema quality score computed for the application design. The schema quality score is processed by the prompt generator 107 in the AGS to generate a modified set of prompts. The modified set of prompts can be used to iteratively enhance the application designs that are generated using the combination of ML models and RAG techniques as described above.

### Updating an Application Design for an Application

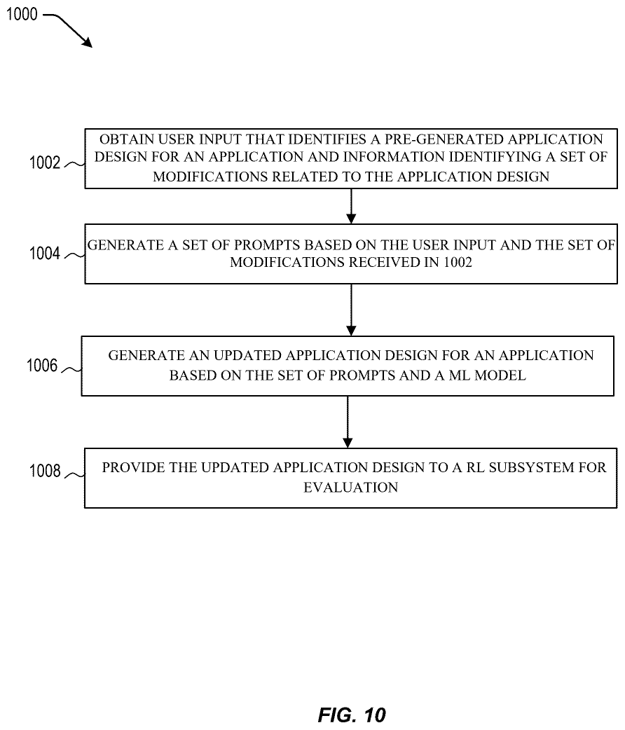

In certain implementations, the AGS 102 may be configured with capabilities to update an application design for an application (based on user input), where the application design is pre-generated by the AGS (e.g., by using the ML models and RAG techniques discussed above). For instance, a user of the AGS may wish to edit (modify) an application design that is generated by the AGS so that the application design is more aligned to the objectives of an entity (for e.g., an organization, an enterprise, or an individual) associated with the user that is providing application design generation functionality to its users. For instance, a user may wish to modify the database schema of an application design by identifying certain database tables, fields, and constraints defined in the schema. In certain embodiments, the information identifying the modifications to be made is provided by the user via user input (e.g., 103) and provided to the AGS for processing. Details related to the processing performed by the AGS 102 to generate an updated application design for an application is described in FIG. 10 below.

FIG. 10 depicts a simplified flowchart 1000 depicting the processing performed by the AGS 102 to generate an updated application design for an application, according to certain embodiments. The processing depicted in FIG. 10 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 10 and described below is intended to be illustrative and non-limiting. Although FIG. 10 depicts the various processing steps occurring in a particular sequence or order, this is not intended to be limiting. In certain alternative embodiments, the processing may be performed in some different order, or some steps may also be performed in parallel.

At block 1002, the AGS 102 obtains user input (e.g., 103) that identifies a pre-generated application design for an application and information that identifies a set of modifications related to the application design. The application may be generated using a combination of ML models (109, 114) and the RAG subsystem (110) as described in FIG. 1 and stored by the AGS in a datastore that is accessible to the AGS. As noted above, in certain examples, the modifications may include modifications to be made to database tables, fields, and constraints defined in the schema of the application design.

At block 1004, a prompt generator in the AGS 102 generates a set of prompts based on the user input and the set of modifications received in 1002. Details of the generation of prompts by the prompt generator 107 is described in the section titled “Prompt Generation.”

At block 1006, the prompt generator provides the set of prompts to an ML model (e.g., 109) which uses the set of prompts to generate an updated application design for the application.

At block 1008, the AGS 102 provides the updated application design to a RL subsystem for further evaluation. Based on the evaluation performed by the RL subsystem as described above, a final application design may be transmitted by the AGS to the user for approval. Based on confirmation received from the user regarding the application design, an application is then generated and deployed for use by a user of the AGS as described above.

The AGS described above addresses several deficiencies of conventional approaches for generating an application design for an application. As previously described, conventional approaches for application design generation typically involve manually translating a set of diverse user requirements into an application design and then generating a full-fledged tangible application based on the application design. This can be a challenging and manual task that is prone to errors. The AGS described herein is capable of accelerating the application development lifecycle by developing a solution that can automatically translate diverse user requirements into an application design for an application. Using the disclosed system, a user can input a set of application requirements for generating an application design for an application and the system can then generate a fully functional application based on the application design.

The disclosed AGS is further capable of generating multiple application designs for an application using a combination of ML techniques and RAG techniques. The AGS evaluates the multiple application designs and selects a single application design that is deemed to be the “best” among the multiple application designs using a Reinforcement Learning (RL) technique.

The evaluation of the multiple application designs performed using the Reinforcement Learning (RL) technique continuously improves the accuracy, stability and relevance of design predictions that are output the AGS, in real-time. As part of generating the multiple application designs and selecting an application design from the multiple application designs, in certain examples, the AGS also includes capabilities to display the selected application design via a UI of a computing device of the user as described in this disclosure.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

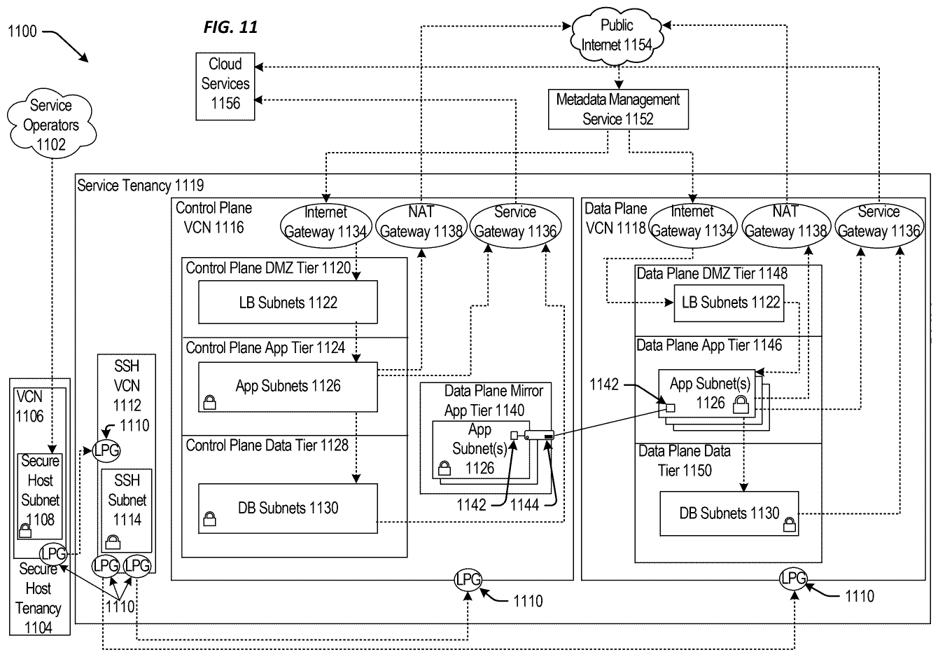

FIG. 11 is a block diagram 1100 illustrating an example pattern of an IaaS architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively couple to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users′, or other customers′, resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

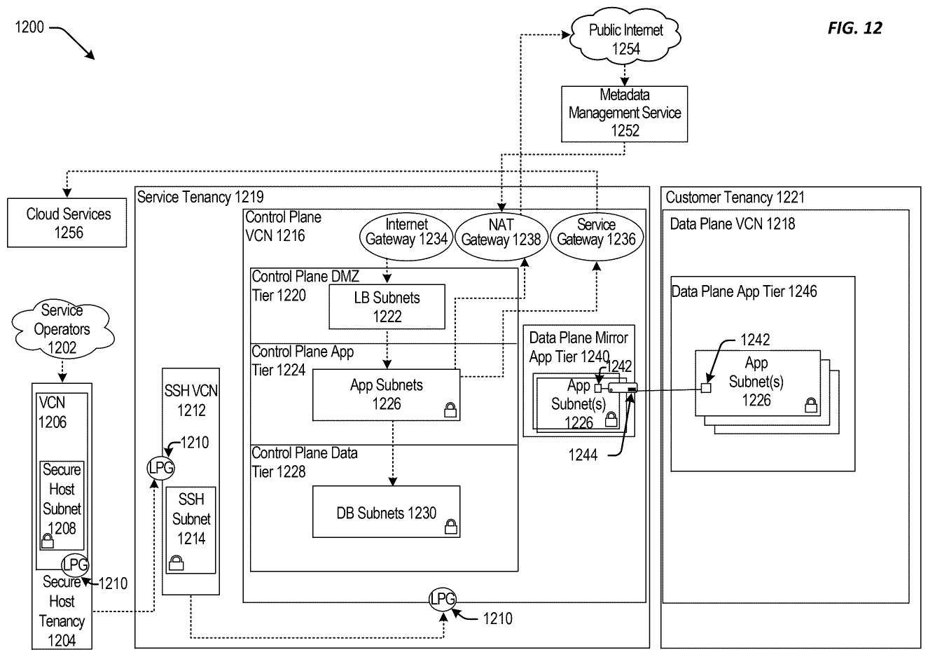

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively couple to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with, Deployment 11 in Region 2.

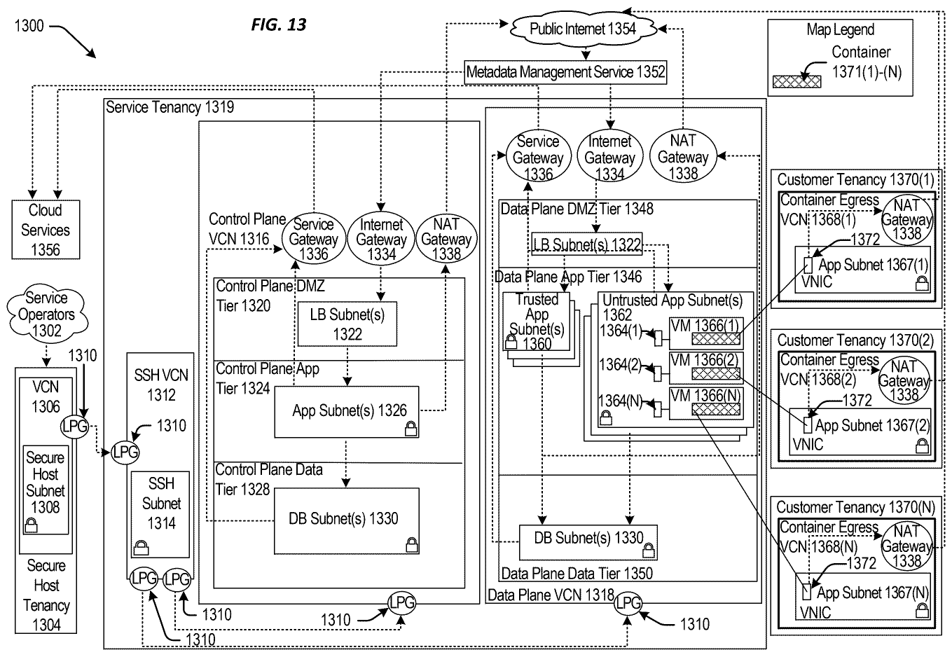

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an

LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364 (1)-(N) that can be communicatively coupled to tenant virtual machines (VMs) 1366 (1)-(N). Each tenant VM 1366 (1)-(N) can be communicatively coupled to a respective app subnet 1367 (1)-(N) that can be contained in respective container egress VCNs 1368 (1)-(N) that can be contained in respective customer tenancies 1370 (1)-(N). Respective secondary VNICs 1372 (1)-(N) can facilitate communication between the untrusted app subnet(s) 1362 contained in the data plane VCN 1318 and the app subnet contained in the container egress VCNs 1368 (1)-(N). Each container egress VCNs 1368 (1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

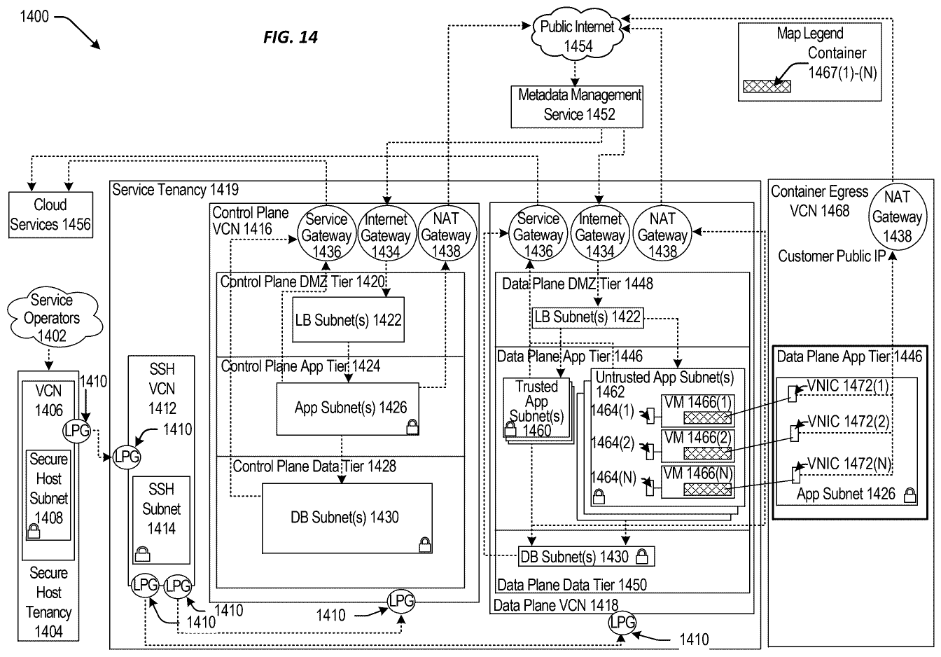

FIG. 14 is a block diagram 1400 illustrating another example pattern of an IaaS architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

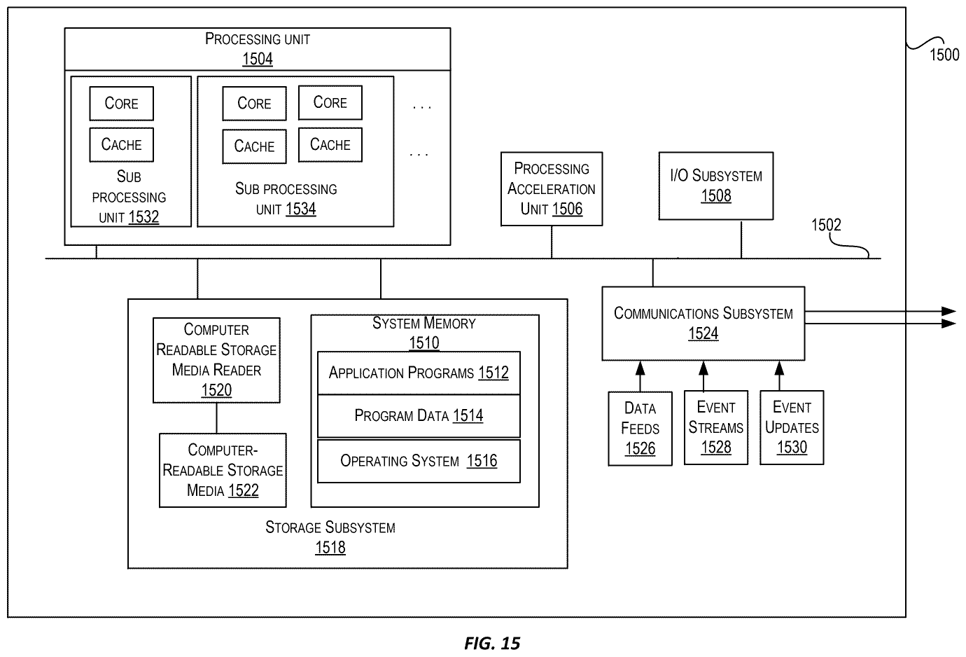

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that comprises software elements, shown as being currently located within a system memory 1510. System memory 1510 may store program instructions that are loadable and executable on processing unit 1504, as well as data generated during the execution of these programs.

Depending on the configuration and type of computer system 1500, system memory 1510 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1504. In some implementations, system memory 1510 may include multiple different types of memory, such as static random access memory (SRAM) or dynamic random access memory (DRAM). In some implementations, a basic input/output system (BIOS), containing the basic routines that help to transfer information between elements within computer system 1500, such as during start-up, may typically be stored in the ROM. By way of example, and not limitation, system memory 1510 also illustrates application programs 1512, which may include client applications, Web browsers, mid-tier applications, relational database management systems (RDBMS), etc., program data 1514, and an operating system 1516. By way of example, operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1518 may also provide a tangible computer-readable storage medium for storing the basic programming and data constructs that provide the functionality of some embodiments. Software (programs, code modules, instructions) that when executed by a processor provide the functionality described above may be stored in storage subsystem 1518. These software modules or instructions may be executed by processing unit 1504. Storage subsystem 1518 may also provide a repository for storing data used in accordance with the present disclosure.

Storage subsystem 1500 may also include a computer-readable storage media reader 1520 that can further be connected to computer-readable storage media 1522. Together and, optionally, in combination with system memory 1510, computer-readable storage media 1522 may comprehensively represent remote, local, fixed, and/or removable storage devices plus storage media for temporarily and/or more permanently containing, storing, transmitting, and retrieving computer-readable information.

Computer-readable storage media 1522 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1500.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of

DRAM and flash memory based SSDs. The disk drives and their associated computer-readable media may provide non-volatile storage of computer-readable instructions, data structures, program modules, and other data for computer system 1500.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
obtaining, by an application generation system, a set of application requirements for generating an application design for an application;
generating, by the application generation system, a first set of multiple application designs for the set of application requirements using a first machine language (ML) model and a set of prompts, wherein the set of prompts are generated based on the user input;
generating, by the application generation system, and based on a set of relevant application designs related to the set of application requirements, a second set of multiple application designs for the set of application requirements using a second machine language (ML) model;
selecting, by the application generation system, a subset of application designs from among the first set of multiple application designs and the second set of multiple application designs based on a set of quality values related to application designs in the first set of application designs and the second set of application designs; and
providing, by the application generation system, the subset of selected application designs as one or more application designs for the application to be generated.

2. The method of claim 1, wherein the set of application requirements comprise at least one of a set of features related to the application, a description of the attributes of the application, a description of one or more pages in the application, and a set of workflows for generating the application design for the application.

3. The method of claim 1, further comprising:
obtaining, by the application generation system, feedback regarding the one or more application designs comprised in the subset of selected application designs;
evaluating, by the application generation system, the feedback to select a final application design for the application from among the subset of selected application designs; and
providing, by the application generation system, the final application design as an application design for the application to be generated.

4. The method of claim 3, wherein the feedback indicates that each application design in the subset of selected application designs is approved, and wherein evaluating the feedback to select a final application design for the application from among the subset of selected application designs comprises:
computing a set of updated quality values for the one or more application designs in the subset of selected application designs;
adding the application designs in the subset of selected application designs and the updated quality values associated with the application designs to a positive samples deque memory in a memory buffer in the application generation system;
identifying the application design from among the subset of selected application designs with the highest quality value; and
providing the identified application design as the final application design for the application to be generated.

5. The method of claim 3, wherein the feedback indicates that at least one application design in the subset of application designs is rejected, and wherein evaluating the feedback to select a final application design for the application from among the subset of selected application designs comprises:
computing an updated quality value for the rejected application design;
adding the rejected application design and the updated quality value associated with the rejected application design to a negative samples deque memory in a memory buffer of the application generation system;
computing a set of updated quality values for the approved application designs in the subset of selected application designs;
adding the approved application designs and the updated quality values associated with the approved application designs to a positive samples deque memory in a memory buffer in the application generation system;
identifying the application design from among the subset of selected application designs with the highest quality value; and
providing the identified application design as the final application design for the application to be generated.

6. The method of claim 3, wherein the feedback indicates that an application design in the subset of selected application designs is approved, and wherein evaluating the feedback to select a final application design for the application from among the subset of selected application designs comprises:
obtaining information identifying a modification to the application design;
generating an application design feature vector for the modified application design; and
computing an updated quality value for the modified application design and adding the modified application design and the quality value associated with the modified application design to a positive samples deque memory in a memory buffer of the application generation system.

7. The method of claim 6 further comprising providing the modified application design as the final application design for the application to be generated.

8. The method of claim 1, wherein selecting, by the application generation system, the subset of application designs from among the first set of multiple application designs and the second set of multiple application designs comprises:
obtaining a set of application design feature vectors that relate to the first set of multiple application designs and the second set of multiple application designs;
for each application design feature vector in the set of application design feature vectors, obtaining a quality value for the application design feature vector; and
selecting the subset of application designs from among the first set of multiple application designs and the second set of multiple application designs based on the quality values obtained for the set of application design feature vectors.

9. The method of claim 8, wherein selecting the subset of application designs comprises:
selecting one or more application design feature vectors from the set of application design feature vectors using a selection policy; and
identifying application designs from among the first set of multiple application designs and the second set of multiple application designs that relate to the selected application design feature vectors.

10. The method of claim 9, wherein the selection policy randomly selects application design feature vectors and the quality values associated with the application design feature vectors from the set of application design feature vectors.

11. The method of claim 9, wherein the selection policy selects one or more application design feature vectors from the set of application design feature vectors having the highest quality values.

12. The method of claim 1, wherein a quality value in the set of quality values represents a value that is obtained as a result of selecting a particular application design from among the first set of application designs and the second set of application designs.

13. The method of claim 1 further comprising:
obtaining a set of quality metrics related to an application design in the first subset of application designs and the second subset of application designs;
for each quality metric in the set of quality metrics, obtaining a weight for the quality metric;
for each quality metric in the set of quality metrics, computing a value for the quality metric; and
computing an application design schema quality score for the application design based on the values computed for the set of quality metrics and the set of weights obtained for the set of quality metrics.

14. The method of claim 1, further comprising:
transmitting the application design schema quality score for the application design to a prompt generator in the application generation system;
generating a set of modified prompts based on the application design schema quality score; and
generating, using the first ML model and the set of modified prompts, an updated application design for the application design.

15. The method of claim 1, further comprising:
obtaining an input that identifies a pre-generated application design for an application and information identifying a set of modifications related to the application design;
generating an updated application design for an application based on a set of prompts and the set of modifications, wherein the set of prompts are generated based on the input; and
providing the updated application design as an application design for the application to be generated.

16. The method of claim 1, wherein the set of relevant application designs are identified by searching a corpus of application designs stored by the application generation system.

17. An Application Generation System comprising:
a memory; and
one or more processors configured to perform processing, the processing comprising:
obtaining a set of application requirements for generating an application design for an application;
generating a first set of multiple application designs for the set of application requirements using a first machine language (ML) model and a set of prompts, wherein the set of prompts are generated based on the user input;
generating, based on a set of relevant application designs related to the set of application requirements, a second set of multiple application designs for the set of application requirements using a second machine language (ML) model;
selecting a subset of application designs from among the first set of multiple application designs and the second set of multiple application designs based on a set of quality values related to application designs in the first set of application designs and the second set of application designs; and
providing the subset of selected application designs as one or more application designs for the application to be generated.

18. The system of claim 17 further comprising:
obtaining feedback regarding the application designs comprised in the subset of selected application designs;
evaluating the feedback to select a final application design for the application from among the subset of selected application designs; and
providing the final application design as an application design for the application to be generated.

19. A non-transitory computer-readable medium storing instructions executable by a computer system that, when executed by one or more processors of the computer system, cause the one or more processors to perform operations comprising:
obtaining a set of application requirements for generating an application design for an application;
generating a first set of multiple application designs for the set of application requirements using a first machine language (ML) model and a set of prompts, wherein the set of prompts are generated based on the user input;
generating, based on a set of relevant application designs related to the set of application requirements, a second set of multiple application designs for the set of application requirements using a second machine language (ML) model;
selecting a subset of application designs from among the first set of multiple application designs and the second set of multiple application designs based on a set of quality values related to application designs in the first set of application designs and the second set of application designs; and
providing the subset of selected application designs as one or more application designs for the application to be generated.

20. The non-transitory computer-readable wherein selecting the subset of application designs from among the first set of multiple application designs and the second set of multiple application designs comprises:
obtaining a set of application design feature vectors that relate to the first set of multiple application designs and the second set of multiple application designs;
for each application design feature vector in the set of application design feature vectors, obtaining a quality value for the application design feature vector; and
selecting the subset of application designs from among the first set of multiple application designs and the second set of multiple application designs based on the quality values obtained for the set of application design feature vectors.
